(19) United States
(12) Patent Application Publication
(10) Pub. No.: US 2009/0126112 A1
(43) Pub. Date: May 21, 2009

(54) Operating Table Column

(75) Inventors: Arnd Kuchenbecker, Saalfeld (DE); Sven Steffens, Poessneck (DE); Steffen Loeser, Unterwellenborn OT Gosswitz (DE)

Correspondence Address: FISH & RICHARDSON PC, P.O. BOX 1022, MINNEAPOLIS, MN, 55440-1022, US

(73) Assignee: TRUMPF Medizin Systeme GmbH, Saalfeld (DE)

(21) Appl. No.: 12/269,219

(22) Filed: Nov. 12, 2008

(30) Foreign Application Priority Data
Nov. 13, 2007 (DE) 102007055463.1

(51) Int. Cl. A61G 13/10; F16M 11/22; A61G 13/02

(52) U.S. Cl. 5/600; 248/415

(57) ABSTRACT

An operating table column is disclosed which includes a column shaft, on which an operating table top can be fixed, and a column foot which can be secured in place on a floor. The column shaft is mounted on the column foot so as to be rotatable about its vertical axis. Electrical transmission elements which interact with one another are arranged on the column shaft and on the column foot for transferring electrical energy, and the column shaft is freely rotatable in relation to the column foot while a transfer of electricity via the transmission elements is maintained.

### CROSS-REFERENCE TO RELATED APPLICATIONS

This application claims priority under 35 U.S.C. §119(a) to German Application No. DE 10 2007 055 463.1, filed on Nov. 13, 2007. The contents of that priority application are hereby incorporated by reference in their entirety.

### TECHNICAL FIELD

The invention relates to an operating table column with a column shaft, on which an operating table top can be fixed, and a column foot which can be secured in position on a floor, wherein the column shaft is mounted on the column foot so as to be rotatable about its vertical axis.

### BACKGROUND

Operating tables are normally designed in two parts and comprise an operating table top, on which a patient can be placed, and an operating table column which bears the operating table top and is secured in position on the floor. The column of the operating table normally has a column shaft which bears the operating table top as well as a column foot which can be secured to the floor. Normally, the column foot can be screwed to the floor. The column shaft is mounted on the column foot so as to be rotatable about its vertical axis; for this purpose, a swivel joint is normally used.

The column shaft is, in many cases, vertically adjustable and has, for this purpose, an electric motor which is connected to a power unit arranged in the column shaft. The supply of electrical energy to the power unit is brought about via the floor. For this purpose, an electric cable is normally used which is guided through the column foot from the floor. The cable does, however, limit the rotational movability of the column shaft.

### SUMMARY

Operating table columns are disclosed herein which have good rotational mobility. In the operating table columns disclosed herein, electrical transmission elements which interact with one another are arranged on the column shaft and on the column foot for transferring electrical energy, wherein the column shaft is substantially freely rotatable in relation to the column foot while a transfer of electricity via the transmission elements is maintained.

The operating table columns disclosed herein have improved rotational movability since the angle of rotation of the column shaft around its vertical axis is not restricted. The column shaft can, therefore, be turned through optional angles of rotation relative to the column foot without the transfer of electrical energy from the column foot to the column shaft being impaired. Proceeding, for example, from a supply cable laid in the floor, electrical energy can be conveyed to the power unit in the column shaft via the electrical transmission elements and a connecting cable attached to them on the side of the shaft, irrespective of the rotary position of the column shaft relative to the column foot.

In some implementations, not only electrical energy but also information signals are transferred via the electrical transmission elements which are arranged on the column shaft and on the column foot. Alternatively or in addition, transmitting and receiving elements, which interact with one another wirelessly, can be arranged on the column shaft and on the column foot in addition to the electrical transmission elements. For example, an infrared or radio link can be provided between the column shaft and the column foot for transferring information signals.

The electrical transmission elements and, where applicable, also the transmitting and receiving elements can be arranged in a housing comprising a housing lower part and a housing upper part which is freely rotatable relative thereto about the vertical axis of the column shaft. The housing surrounds the electrical transmission elements and protects them from mechanical interference and forms, in addition, a dust protection.

The lower part of the housing can be secured in position on the floor, for example, be screwed to the floor.

It may be provided for the lower part of the housing to be inserted into a recess in the floor.

It has proven to be advantageous when the column foot comprises a floor plate which surrounds the lower part of the housing in a ring shape. The floor plate can preferably be inserted into a recess in the floor together with the lower part of the housing. The floor plate can preferably be screwed to the floor.

The upper part of the housing is preferably secured in position on the column shaft. In some implementations, the upper part of the housing is screwed to the column shaft.

In order to simplify the mounting of the operating table column on the floor, it is favorable when the position of the lower part of the housing can be adjusted transversely to the vertical axis of the column shaft.

In order to secure the lower part of the housing in place, in some implementations the lower part of the housing can be clamped between a base plate of the column foot, which can be fixed to the floor, and a clamping element. This makes a floating mounting of the lower part of the housing possible, allowing the position of the lower part of the housing to be easily adjusted transversely to the vertical axis of the column shaft. The lower part of the housing can, for example, have an edge section which projects outwards radially to the vertical axis and which can be positioned between the clamping element and the base plate and clamped between these two components.

In a particularly preferred development, the electrical transmission elements are surrounded by a water-tight housing. For example, a sealing element, e.g., a sealing ring, can be arranged between the lower part of the housing and the upper part of the housing. This sealing element prevents any liquid from penetrating the interior of the housing and, therefore, the area of the electrical transmission elements.

The transfer of electrical energy via the electrical transmission elements can be brought about, for example, by inductively coupling the electrical transmission elements to one another. Alternatively, an ohmic coupling can be provided between the electrical transmission elements.

In one embodiment which is inexpensive to produce, the electrical transmission elements comprise at least one slip ring and a sliding contact making contact with the slip ring.

The sliding contact is preferably of a ring-shaped design. This makes an areal abutment of the sliding contact on the slip ring possible, wherein a transfer of energy via the at least one slip ring and the sliding contact associated with it is ensured irrespective of the rotary position of the column shaft relative to the column foot.

It is favorable when the column shaft can be locked on the column foot, preferably independently of the rotary position taken up by the column shaft relative to the column foot. In this respect, it is particularly advantageous when the transfer of electrical energy from the column foot to a power unit of the column shaft can be interrupted when the locking is released. With such an embodiment, electrical energy can be conveyed to the power unit of the column shaft via the transmission elements only when the column shaft is locked on the column foot. If, on the other hand, the locking is released so that the column shaft can be turned about its vertical axis, the transfer of energy is interrupted at the same time. As a result, the generation of sparks during rotation of the column shaft can be reliably prevented. In addition, mechanical wear and tear on the electrical transmission elements can be kept small as a result of such a configuration.

An electrical switching unit is preferably arranged in the column shaft and this switching unit interrupts the supply of electrical energy to the power unit automatically when the locking is released. The electrical switching unit can be interposed into the electrical connection between the power unit and the at least one electrical transmission element arranged on the column shaft. If the locking is released in order to turn the column shaft about its vertical axis, the electrical connection between the at least one transmission element on the side of the shaft and the power unit will be interrupted automatically.

In one preferred embodiment, the operating table column has a foot pedal for locking the column shaft to the column foot, and the transfer of electrical energy from the column foot to the power unit of the column shaft can be interrupted automatically as a function of the position of the foot pedal. With such a configuration, the supply of electrical energy to the power unit is enabled or interrupted as a function of the position of the foot pedal. If the foot pedal takes up a position in which the locking is released and, consequently, the column shaft can be turned relative to the column foot, the supply of electrical energy to the power unit is interrupted. If the foot pedal, on the other hand, takes up a position in which the column shaft is locked, the supply of electrical energy to the power unit is automatically enabled.

In some implementations, a sensor is provided for detecting the position of the foot pedal. The sensor interacts with a switching unit for interrupting the electrical connection between the at least one transmission element on the side of the shaft and the power unit of the column shaft.

The position of the foot pedal can preferably be detected without contact by means of the sensor. The sensor can, for example, have a sensor element which is sensitive to magnetic fields, in particular, a Hall element. It may be provided for the foot pedal to be fixed on a rotatably mounted shaft, the rotary position of which can be detected by the sensor. The foot pedal may be fixed on the shaft in a non-rotatable manner.

The switching unit, with the aid of which the supply of electrical energy to the power unit can be interrupted, preferably has at least one relay. Alternatively, semiconductor components can, for example, be used.

The details of one or more embodiments of the invention are set forth in the accompanying drawings and the description below. Other features and advantages of the invention will be apparent from the description and drawings, and from the claims.

### BRIEF DESCRIPTION OF DRAWINGS

FIG. 1 shows a perspective illustration of an operating table column according to the invention.

FIG. 2 shows a perspective illustration of the lower end area of the operating table column from FIG. 1.

FIG. 3 shows a perspective illustration of the lower end area of the operating table column from FIG. 1 in the manner of an exploded drawing.

FIG. 4 shows a further perspective illustration of the lower end area of the operating table column from FIG. 1 in the manner of an exploded drawing.

### DETAILED DESCRIPTION

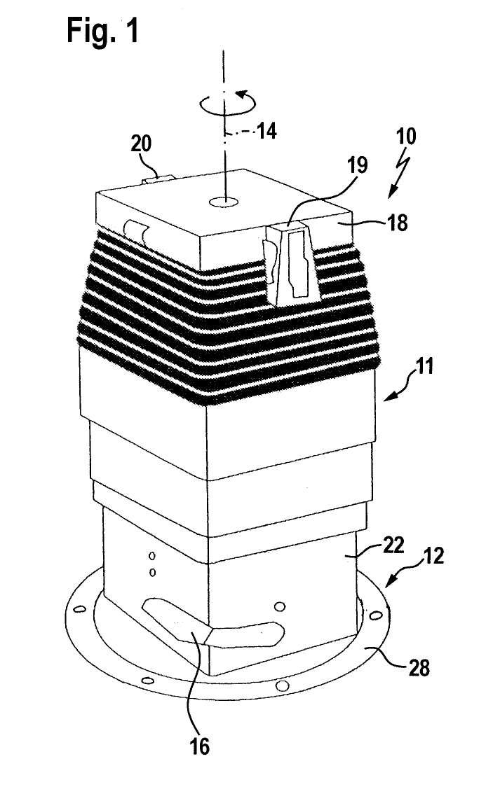

An operating table column 10 is schematically illustrated in FIG. 1. Operating table column 10 includes a column shaft 11, on which an operating table top, which is known per se and not, therefore, illustrated in the drawings, can be fixed, and a column foot 12 which can be screwed to a floor. The column shaft 11 is freely rotatable about its vertical axis 14 relative to the column foot 12 and can be fixed on the column foot 12 in any optional rotary position as a result of actuation of a foot pedal 16.

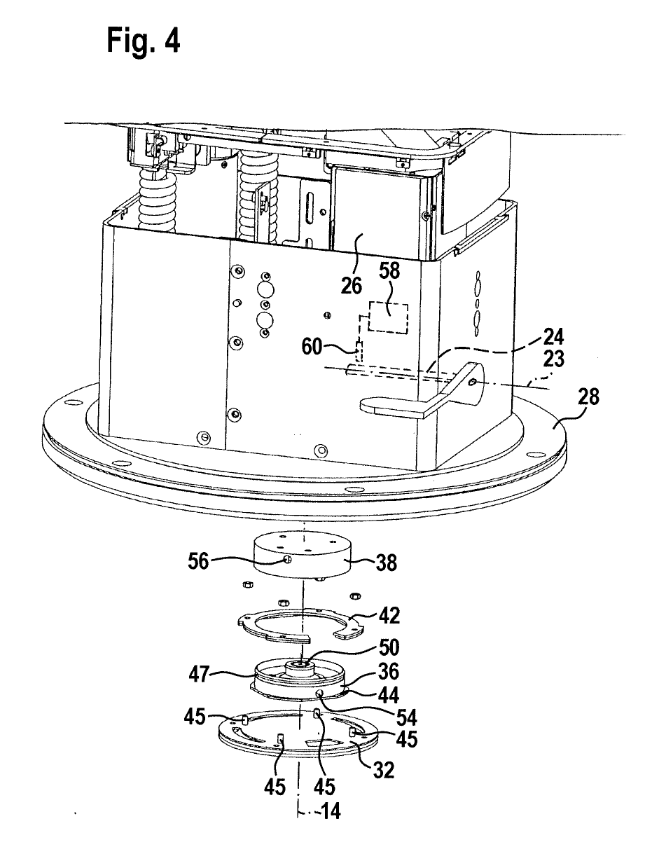

The column shaft 11 has, in the embodiment illustrated, a column head 18 with connecting elements 19, 20 for the releasable connection of an operating table top to the operating table column 10. In addition, the column shaft 11 has a column base 22, on which the foot pedal 16 is mounted on the outside so as to be pivotable about a pivot axis 23. The foot pedal 16 is held non-rotatably on a shaft 24 which is mounted in the column basis 22 so as to be rotatable about the pivot axis 23 (FIG. 4).

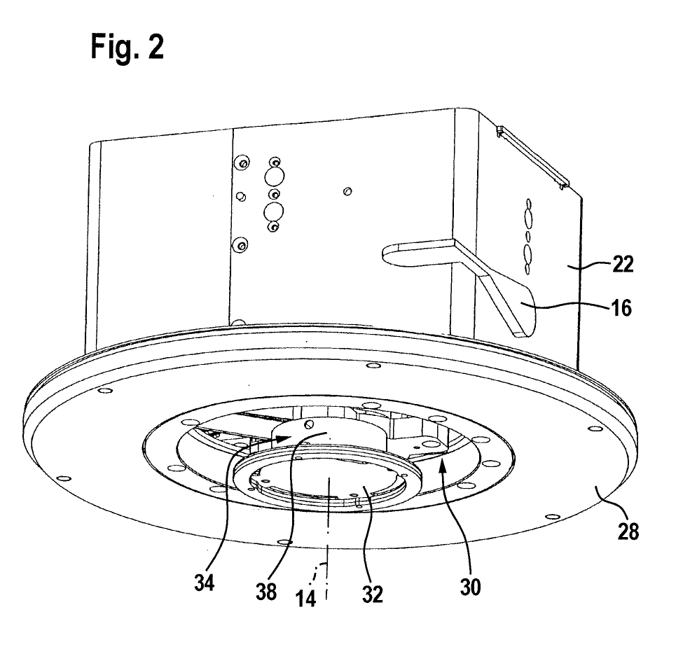

The column head 18 can be adjusted in its height relative to the column base 22. For this purpose, the column shaft 11 has, in the customary manner, adjusting elements which are supplied with electrical energy by a power unit 26 (FIG. 4) arranged in the column shaft 11. The column foot 12 comprises an annular floor plate 28 which can be inserted into a recess in the floor and screwed to it. The floor plate 28 defines, beneath the column shaft 11, a hollow space 30 (FIG. 2) which accommodates a base plate 32 which can be screwed to the floor and a housing 34.

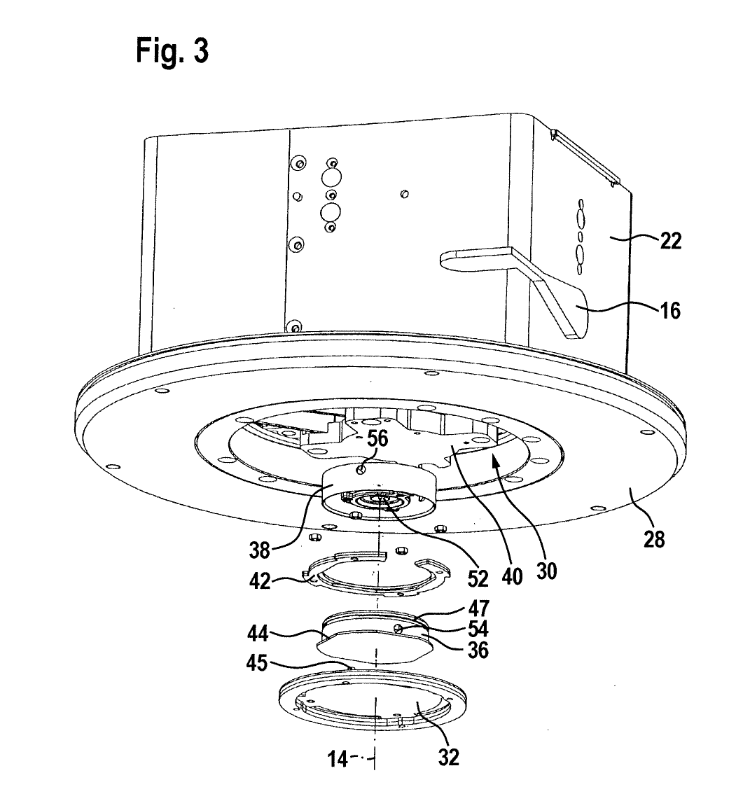

Referring now to FIG. 3, the housing 34 is designed in two parts and comprises a housing lower part 36 and a housing upper part 38. The upper part 38 of the housing is screwed to a central supporting part 40 of the column shaft 11 and can, therefore, be turned about the vertical axis 14 together with the column shaft 11. The lower part 36 of the housing is fixed to the base plate 32 which can be secured in position so as to be stationary on the floor. A clamping ring 42 is used for this fixing in position and this can be placed on an edge section 44 of the lower part 36 of the housing, which projects radially outwards in relation to the vertical axis 14, and can be clamped to the base plate 32 by means of clamping bolts 45. The lower part 36 of the housing can, therefore, be offset transversely to the vertical axis 14 in a simple manner. For this purpose, it is merely necessary to release the clamping connection between the clamping ring 42 and the base plate 32.

The upper part 38 of the housing can be placed on the lower part 36 of the housing with a sealing ring 47 positioned therebetween so that the housing 34 is, altogether, of a water-tight configuration.

Referring now to FIGS. 3 and 4, the lower part 36 of the housing accommodates a first electrical transmission element in the form of a slip ring 50 which interacts with a second electrical transmission element in the form of a sliding contact 52 which is arranged in the upper part 38 of the housing. The sliding contact 52 is of a ring-shaped design and rests areally on the slip ring 50 and so an electrical connection is ensured between the slip ring 50 and the sliding contact 52 irrespective of the rotary position of the column shaft 11 relative to the column foot 12. An electrical supply cable (not shown) which is laid in the floor can be connected to the slip ring 50 via a lateral opening 54 in the lower part 36 of the housing and a connecting cable (also not shown), which runs within the column shaft 11 and via which the sliding contact 52 can be connected to the power unit 26, can be connected to the sliding contact 52 via a lateral opening 56 in the upper part 38 of the housing. The power unit 26 can, therefore, be supplied with electrical energy via the floor irrespective of the rotary position of the column shaft 11 without the rotational movability of the column shaft 11 relative to the column foot 12 being restricted.

Referring to FIG. 4, an electrical switching unit in the form of a relay 58 is interposed into the electrical connection between the sliding contact 52 and the power unit 26. The relay 58 interacts with a sensor 60, which detects the rotary position of the shaft 24 without contact. This arrangement offers the possibility of interrupting and enabling the supply of electrical energy to the power unit 26 automatically as a function of the rotary position of the shaft 24 and, therefore, as a function of the position of the foot pedal 16. The supply of electrical energy to the power unit 26 is only enabled when the foot pedal 16 takes up a position in which the column shaft 11 is locked to the column foot 12. If the locking is released, the column shaft 11 can be turned about the vertical axis 14; at the same time, the supply of electrical energy to the power unit 26 within the column shaft 11 is interrupted by means of the relay 58. As a result, the generation of sparks in the area between the slip ring 50 and the sliding contact 52 during turning of the column shaft 11 will be prevented. In addition, any wear and tear on the slip ring 50 and the sliding contact 52 will be kept small.

A number of embodiments of the invention have been described. Nevertheless, it will be understood that various modifications may be made without departing from the spirit and scope of the invention. Accordingly, other embodiments are within the scope of the following claims.

What is claimed is:

1. An operating table column, comprising:
a column shaft adapted to have an operating table top fixed on it,
a column foot adapted to be secured in position on a floor, wherein the column shaft is mounted on the column foot so as to be rotatable about a vertical axis of the column shaft, and
electrical transmission elements, adapted to interact with one another, arranged on the column shaft and on the column foot, the electrical transmission elements being configured to transfer electrical energy,
wherein the column shaft is freely rotatable in relation to the column foot while a transfer of electricity via the transmission elements is maintained.

2. An operating table column of claim 1, further comprising a housing in which the electrical transmission elements are arranged.

3. An operating table column of claim 2 wherein the housing comprises a housing lower part and a housing upper part freely rotatable relative to the housing lower part about the vertical axis of the column shaft.

4. An operating table column of claim 3, wherein the lower part of the housing is adapted to be secured in position on the floor.

5. An operating table column of claim 4, wherein the column foot comprises a floor plate surrounding the lower part of the housing in a ring shape.

6. An operating table column of claim 3, wherein the upper part of the housing is adapted to be secured in position on the column shaft.

7. An operating table column of claim 3, wherein the lower part of the housing is adjustable transversely to the vertical axis of the column shaft.

8. An operating table column of claim 4, wherein the lower part of the housing is adapted to be clamped between a base plate fixable to the floor and a clamping element.

9. An operating table column of claim 3, wherein a sealing element is arranged between the lower part of the housing and the upper part of the housing.

10. An operating table column of claim 1, wherein the electrical transmission elements comprise at least one slip ring and a sliding contact that is in contact with the slip ring.

11. An operating table column of claim 10, wherein the sliding contact is ring-shaped.

12. An operating table column of claim 1, wherein the column shaft is adapted to be locked on the column foot, wherein the operating table column is adapted so that the transfer of electrical energy from the column foot to a power unit of the column shaft is interrupted when the locking of the column shaft is released.

13. An operating table column of claim 12, further comprising an electrical switching unit arranged in the column shaft and configured to interrupt the supply of electrical energy to the power unit automatically when the locking of the column shaft is released.

14. An operating table column of claim 13, further comprising a foot pedal configured to lock the column shaft to the column foot, wherein the transfer of electrical energy from the column foot to the power unit of the column shaft is interrupted automatically as a function of the position of the foot pedal.

15. An operating table column of claim 14, further comprising a sensor configured to detect the position of the foot pedal, wherein the sensor interacts with the switching unit to interrupt the electrical connection when the foot pedal is in a predetermined position.

16. An operating table column of claim 15, wherein the sensor is configured to detect the position of the foot pedal without contact.

17. An operating table column of claim 15, wherein the switching unit has a relay.

18. An operating table column, comprising:
a column shaft adapted to have an operating table top fixed on it,
a column foot adapted to be secured in position on a floor, wherein the column shaft is mounted on the column foot so as to be rotatable about a vertical axis of the column shaft,
electrical transmission elements, adapted to interact with one another, arranged on the column shaft and on the column foot, the electrical transmission elements being configured to transfer electrical energy, and
a housing comprising a housing lower part and a housing upper part freely rotatable relative to the housing lower part about the vertical axis of the column shaft, one of the electrical transmission elements being arranged in the housing upper part and the other being arranged in the housing lower part,
wherein the column shaft is freely rotatable in relation to the column foot while a transfer of electricity via the transmission elements is maintained.

19. An operating table column of claim 18 wherein the electrical transmission elements comprise at least one slip ring and a ring-shaped sliding contact making contact with the slip ring.

20. A operating table column of claim 18 wherein the slip ring and the ring-shaped sliding contact together define an areal abutment, wherein a transfer of energy via the electrical elements is ensured irrespective of the rotary position of the column shaft relative to the column foot.
